(19) United States
(12) Patent Application Publication
(10) Pub. No.: US 2006/0255909 A1
(43) Pub. Date: Nov. 16, 2006

(54) Security system

(76) Inventors: Frank Pavatich, Victoria (AU); Christopher John Englefield, Victoria (AU); Sophocies Tsolakis, Victoria (AU)

Correspondence Address: KENYON & KENYON LLP, ONE BROADWAY, NEW YORK, NY, 10004, US

(21) Appl. No.: 10/541,276

(22) PCT Filed: Oct. 30, 2003
(86) PCT No.: PCT/DE03/03611

§ 371 Date: Apr. 12, 2006

(30) Foreign Application Priority Data
Jan. 14, 2003 (DE) 10301146.3

(51) Int. Cl. G05B 19/00

(52) U.S. Cl. 340/5.64; 340/5.72; 340/5.61

(57) ABSTRACT

A safety system including an electronic key that has a transmitter, and a protected object having a radio base station which includes a receiver, is provided. The transmitter and the receiver are designed to communicate in order to exchange authentication data. The radio base station regularly monitors the natural high frequency (HF) signal level received on the part of the receiver and detects interferences in the natural HF signal level, so as to make possible the detection of a relay station.

### FIELD OF THE INVENTION

The present invention relates to a safety system, especially to a passive safety (security) system for vehicles.

### BACKGROUND INFORMATION

Currently existing passive vehicle safety (security) systems, for access to or for setting in motion vehicles, use remotely operated electronic keys, which include a transmitter that sends authentication data to a receiver, that is present in the vehicle, when a transponder of a key is excited, if the key is present within a predetermined range of the receiver. The communications protocol activated between the transmitter and the receiver uses a high frequency interface for carrying the transmitted data as well as all the data sent by the vehicle to the key. The high frequency (HF) interface has a limited operating range in order to ensure that the communications connection is interrupted if a person having possession of the key leaves the immediate proximity to the vehicle.

Passive safety systems are easily exposed to attacks by unauthorized persons who use listening devices that are brought into the vicinity of the vehicle, and the key. Such devices are used to excite the key, to receive the transmissions sent by the key and to retransmit the transmissions to the vehicle. The listening device, which often includes one or more relay stations, normally includes a receiver and an amplifier within the range of the key, in order to transmit the intercepted signal to a receiver and an amplifier in the vicinity of the vehicle, so as to obtain access to the vehicle.

The specifications of Australian Patent Applications 743933 and 42419/99 and 76313/01 describe safety systems which use unique access protocols for the communications between the key and the vehicle, and which in addition may be used for transmitting the authentication data, for the purpose of detecting or preventing attacks on the part of a relay station. The access protocol is the communications protocol that is carried out if the key is excited or triggered for communications on the part of the vehicle. The access protocol includes a number of tests that are used for assisting in the detection of the relay station, for example the two-tone test described in the specifications and the transmission signal deviation test. The two-tone test is based on detecting distortion products of the third order that are generated by the relay station, and it is a function of the linearity of the amplifier and the mixer used in the relay station. Since, however, over time highly linear amplifiers and mixers have become available, it is difficult to detect distortion products of the third order generated by the relay station. It is therefore desirable to utilize a different technology that will detect a relay station attack, or is of assistance in detecting such an attack.

### SUMMARY

The present invention provides a safety (security) system that includes an electronic key which has a transmitter, and a protected object having a radio base station that has a receiver, the transmitter and the receiver being designed in such a way that they communicate with each other, so as to exchange authentication data, wherein the radio base station regularly monitors the natural high frequency (HF) signal level received on the part of the receiver; and the radio base station detects interferences in the HF signal level, so as to make possible the detection of a relay station.

The present invention also provides a communications method carried out by a safety (security) system that includes an electronic key which has a transmitter, and a protected object having a radio base station that has a receiver, the method including the transmission of authentication data from the transmitter to the receiver, wherein the radio base station monitors the natural high frequency (HF) signal level received on the part of the receiver, and detects interferences in the HF signal level, so as to make possible the detection of a relay station.

### BRIEF DESCRIPTION OF THE DRAWINGS

FIG. 1 shows a schematic representation of a relay station attack by an unauthorized person.

FIG. 2 shows a schematic representation of an example embodiment of a safety system and a relay station.

FIG. 3 shows a block diagram of the safety system.

FIG. 4 shows a flowchart of a control process of a radio base station of the safety system.

### DETAILED DESCRIPTION

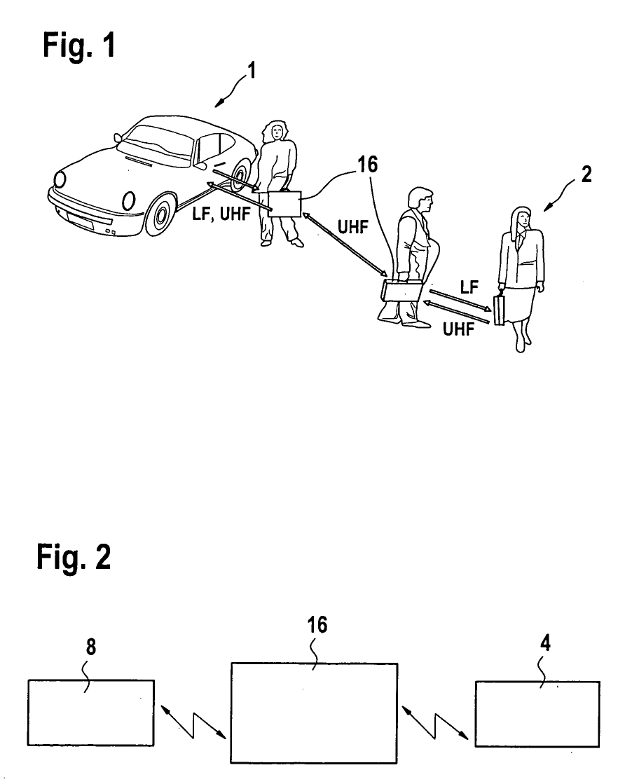

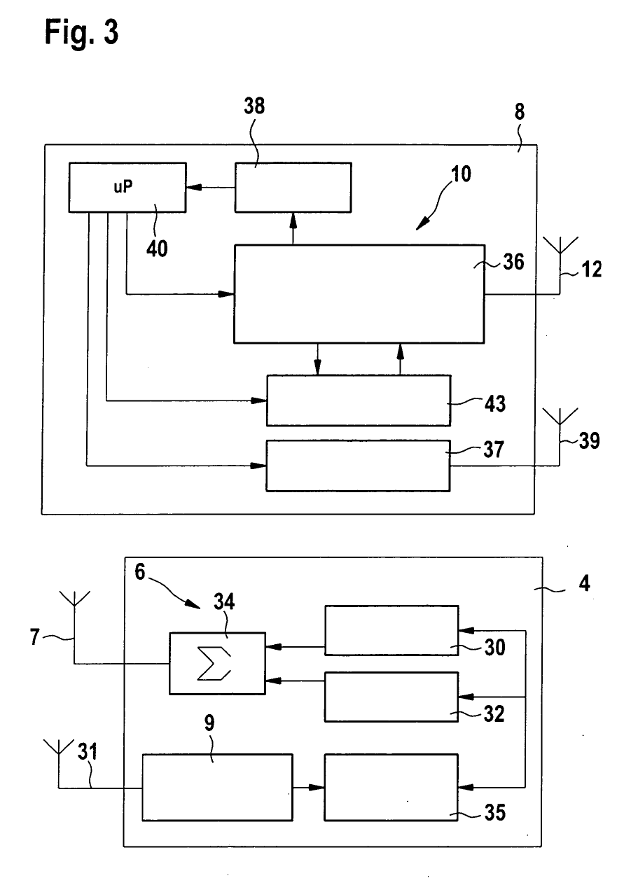

A protected object, such as a vehicle 1, as is shown in FIG. 1, is equipped with a passive safety system which permits a legitimate user 2, who is carrying a key 4 (shown in FIGS. 2 and 3), access to and the use of vehicle 1, when the key 4 is present within a previously determined range of vehicle 1. A relay station attack may be undertaken in an attempt to attain access to the vehicle without the permission of the legitimate user, namely by using listening devices which include one or more relay stations 16. User 2 of vehicle 1 may be in possession of the key, and a first relay station 16 may be used to excite the key and to initiate a transmission on the part of the key according to the access protocol. The signals of the key are retransmitted to an additional relay station 16 which is being kept ready by an attacker in the vicinity of the vehicle. Second relay station 16, in turn, retransmits the signals to vehicle 1. This produces a communications connection between the key and vehicle 1, although the owner is not present within the previously determined range of the vehicle, which is normally required for initiating the access protocol.

The passive safety (security) system, as shown in FIGS. 2 and 3, includes an electronic key 4 having a transmitter 6 and a transmission antenna 7, a radio base station 8 having a receiver 10 and receiving antenna 12. Radio base station 8 is accommodated in a protected object, such as vehicle 1, and controls access to the protected location and/or to starting the vehicle. If key 4 is brought within a certain range of antenna 12 of receiver 10, receiver 10 excites the transponder of key 4 or is triggered to excite the latter, and thereby induces transmitter 6 to begin the transmission to receiver 10. The data are transmitted by using HF signals which produce a communications connection between key 4 and radio base station 8. The data transmitted between key 4 and radio base station 8 are determined by a communications access protocol, which key 4 and radio base station 8 comply with, and which protocol includes the transmission of authentication data from key 4 to receiver 10. Access to the protected region and/or to starting the vehicle is permitted by radio base station 8 only if the transmitted authentication data match the authentication data stored by radio base station 8.

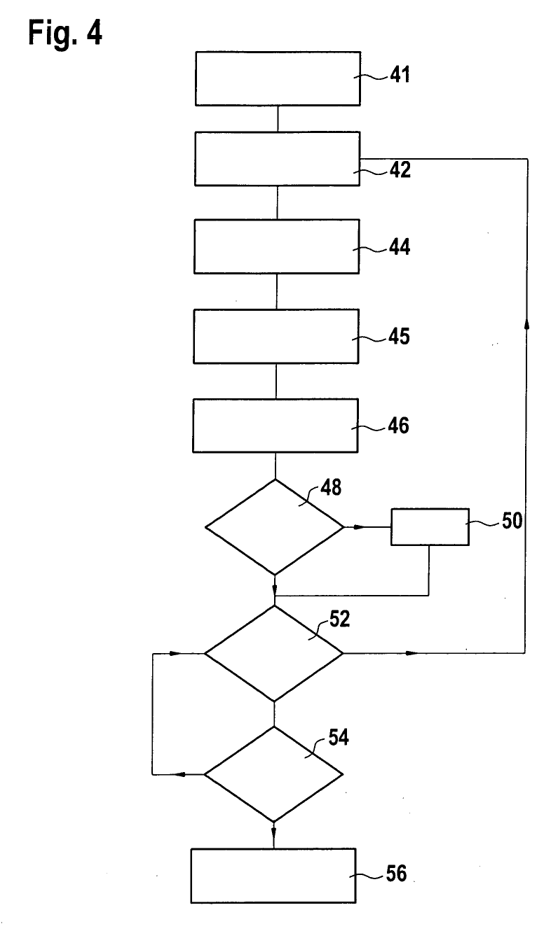

Key 4 and radio base station 8 include a series of safety (security) features, such as those described in the access protocol specifications. The components of key 4 and radio base station 8 are the same as is described in the access protocol specifications, with the exception that a microcontroller 40 of radio base station 8 is designed in such a way that a control process is carried out, as is described below with reference to FIG. 4. This may be achieved by setting the control software of microcontroller 40 and/or by installing an application-specific integrated circuit (ASIC) as a part of microcontroller 40, for carrying out at least a part of the control process. Key 4 includes a microcontroller 35, which includes the control software for controlling the key components as a part of the communications protocol. Microcontroller 35 controls transmitter 6, which includes a first oscillator 30 for generating a first fundamental tone 60 and a second oscillator 32 for generating a second fundamental tone 62. The frequency signals generated are combined by a combiner (antenna filter) or summation amplifier 34 for transmission by UHF transmitting antenna 7. Microcontroller 35 is also connected to control oscillators 30 and 32, so that it is able to bring about a frequency shift or a frequency deviation supported by the data to be transmitted. Microcontroller 35 is also suitable for receiving control data from radio base station 8 via a low-frequency receiver 9 and an antenna 31. Key 4 includes a transponder circuit configuration (as part of receiver 9) to excite or trigger key 4 when it is present within a predetermined range of radio base station 8. Within this region, an excitation signal on the part of the vehicle may be generated when a certain event occurs, such as the lifting of the door handle or the like.

As soon as key 4 is excited or activated, communications protocol for access legitimacy to the vehicle is put into operation.

Radio base station 8 includes a microcontroller 40 which has control software, and which controls the operation of the components of radio base station 8. These parts include a UHF receiver 36 which is connected to receiving antenna 12, in order to make available an output of the data received for microcontroller 40.

An analog to digital converter 38 is used for converting the analog output signals of receiver 36 into digital form for microcontroller 40. These signals include an RSSI (input signal strength indicator) output, which makes available spectral signature data for microcontroller 40. Intermediate frequency data generated by receiver 36 are passed on to a filter 43 and then conducted back to receiver 36, in order to filter out data contained in the signals. Filters 43 are “switched” intermediate frequency filters having bandwidths that are set by microcontroller 40 in agreement with the access protocol. Radio base station 8 also has a low frequency transmitter 37 and an antenna 39 for transmitting data from microcontroller 40 to key 4. Low frequency transmitter 37, antennas 39 and 31, and low frequency receiver 9 are designed in such a way that a low frequency communications connection is produced only if key 4 and radio base station 8 are within a common region, e.g., within the protected region, for instance, inside the vehicle. For this, transmitting antenna 39 may be developed, for instance, in the form of a coil that is accommodated in an ignition system, so that a connection is produced with antenna 31 only when key 4 is introduced into the ignition switch of the ignition system. The lower frequency channel connection is used in order to transmit synchronization control data from the radio base station to key 4, so that these can be used when key 4 is excited the next time. The synchronization control data are used for setting the times for various parts or components of the messages transmitted in the access authorization protocol.

The access protocol makes use of a series of techniques in order to detect a relay station attack, especially the interference on the part of a possibly present relay station 16. These techniques include a two-tone test based on the level of intermodulation distortion products of the third order, which are received by radio base station 8 and are connected with the transmission of the fundamental tones of oscillators 30 and 32. The techniques also include time lapses, performance and frequency deviations which are used in the transmission of authenticating data and represent a component of the communications access protocol. A series of tests are carried out by microcontroller 40, based on the data received as a part of the access protocol. If a condition of the test is satisfied, a safety flag is set for the respective test in microcontroller 40. The status of the flag present in the microcontroller is used to determine whether a relay station 16 is present, and especially whether access to the vehicle is to be granted. For the support of these techniques, radio base station 8 executes an additional continual test which is designated as “noise test” below.

The noise test involves the detection of interferences or abrupt changes to the extent of the high frequency noise in the natural environment of radio base station 8 of vehicle 1. All relay stations 16, which use high frequency amplification, irrespective of the linearity of their amplifiers, will not only amplify the signals that are of interest in the access protocol, but also any HF noise within the passband of relay station 16. The extent of the amplification is a function of the overall degree of amplification of the connection produced by a relay station, and the higher the degree of amplification of the connection, the higher is the probability of a detection.

In order to fully use the detection techniques of the access protocol, the passband of radio base station 8 has a sufficient bandwidth so that it may be partitioned into a number of channels. The minimum filter passband of each relay station 16 will normally be greater than that of radio base station 8 or equal to it. When a relay station 16 is activated, the extent of the noise in the passband of the relay station is increased. This may be recognized in that radio base station 8 monitors any change of the DC noise level in the overall passband.

Radio base station 8 is in a position to carry out the noise test in the light of the control process shown in FIG. 4. The process begins at step 41, when radio base station 8 has detected that the engine of the vehicle has been shut down, and the user of the vehicle has left in the regular manner, namely by locking the vehicle or by distancing the key from the vicinity of the vehicle. At step 41 microcontroller 40 turns off all its safety flags for the relay station attack detection, and at step 42 a timer T is set to 0. Timer T continually measures the elapsed time in seconds. At step 44, the microcontroller samples the RSSI (input signal strength indicator) output of UHF receiver 36 (via A/D converter 38) in order to receive random samples of its overall passband for the received signals at a number of frequency channels.

If, for example, the passband of radio base station 8 is at 1.6 MHz, and the RSSI output is in a position to partition this band into 100 kHz channels, then 16 random data samples may be obtained for the entire passband for the corresponding channels. At step 44, microcontroller 40 collects a number of random samples \overline{x}[n], for instance, 20, for each frequency channel, and these are used at step 45 for recording an average value \overline{x}n. The average value \overline{x}n is stored frequency binvalue for each channel in a corresponding intermediate memory of microcontroller 40. The intermediate memories are set to a capacity that makes it possible to keep up a selected record of average values.

The noise test is carried out at step 46. The noise test may be very simple, and may consist of determining whether a selected number of frequency bins have a binvalue which is greater than a predetermined threshold value. If, for example, the current \overline{x}n value is greater than a predetermined threshold value for 13 of the 16 bins, the noise test may be regarded as having satisfied its conditions. Alternatively, the noise test conditions may also be regarded as having been fulfilled if a number of past \overline{x}[n] random samples have exceeded the threshold value. The noise test is regarded as being only satisfactory if a number of the channels exceeds the threshold, and a number of additional random samples, collected for these channels, confirm that the threshold value has actually been exceeded. The additional random samples are taken in order to reduce the probability of erroneous detection. It is assumed that a legitimate interference not using a relay station would not occupy an entire passband for a relay station, and would therefore interfere in only one or two of the frequency channels.

The level of the threshold value is dynamic. It is determined according to step 41, by random samples of the HF environment, immediately after the engine has been shut down and the vehicle has been left in the regular manner. If the threshold value has been set based on this HF environment random sample, according to step 41, all frequency bins are set anew.

An additional alternative method for carrying out the noise test is based on the principle that the HF noise is regarded as white noise, and is therefore distributed according to a Gaussian probability density function (PDF). In order to detect interferences which relate to an increase in the average white noise level, microcontroller 40 executes a probability density function, A being the signal level of the white Gaussian noise. This probability density function p (supported by the random sample data) determines the probability that a certain signal level A has been achieved. This probability density function, applied by microcontroller 40, is:

$$p ( x ; A ) = \frac{1}{\sqrt{{( 2 {πσ}^{2} )}^{N}}} exp [ - \frac{1}{2 {σ}^{2}} {\sum }_{n = 0}^{N - 1} {( x [ n ] - A )}^{2} ]$$

where
“n”=the random sample from which the data are taken,
“N”=the number of random samples that have been taken for one frequency channel,
“x”=the random sample data,
“ρ²”=the variance of x′
“A”=the signal level of the white Gaussian noise.

Microcontroller 40 is able to carry out the probability density function (PDF) so that one is able to solve for A or for the probability p. If the microcontroller sets the probability p to a fixed value, a value of A is determined for this probability by using the probability density function (PDF). The probability may be set high enough so that false detection is minimized. For example, a p of 0.9 indicates that, with a high probability, level A has been attained, whereas a p of 0.5 means a lesser certainty. The value A obtained from the probability density function (PDF) is used as a dynamic threshold value as opposed to a measured value for A that is obtained directly from the random sample data. The measured value for A can be an average over all random samples in the frequency bins or an average over a few frequency bins. If the measured value for A exceeds the threshold value determined by the probability density function (PDF), the noise test conditions are regarded as being satisfied. Alternatively, the random sample data may be used to obtain a value for A, and then the random sample data and the value for A may be used in the probability density function (PDF) which is executed by microcontroller 40, so as to generate measured values for p at various time intervals. For every measured value of p that is determined by microcontroller 40 at step 46, that value is then compared to a selected threshold value for p, such as 0.7, and if the measured value for p exceeds the threshold value, then the noise test conditions are regarded as being satisfied.

The probability density function (PDF) has the advantage that it filters out any peaks introduced by chance events, but on the other hand it makes for costly computing by microcontroller 40. The probability density function (PDF) may also be used as an additional test as soon as the first random sample threshold test has provided a positive result and indicates that there is a relay station 16 present.

At step 49 it is determined whether noise test conditions have been satisfied. If this is the case, the safety flag for noise is set at step 50. Steps 42 to 48 should all be executed within milliseconds. In step 52 it is determined whether T has reached a scanning time of y seconds, such as 10 seconds. If not, the control process runs through a loop, continually seeking a trigger signal in order to introduce the communications with key 4, at step 54. The trigger signal may be an introductory signal caused by lifting one of the door handles or activating a door handle actuator, or it may be a signal that is generated when the ignition for starting the engine is activated.

If no trigger signal is received, the control process tries to determine, by testing the value of T at step 52, whether y seconds have passed. If a trigger signal is received, microcontroller 40 executes its part of the access protocol at step 56.

If timer T has reached y seconds in step 52, a continual loop is triggered, and steps 40 to 48 are carried out, so that an additional set of binvalues are made available for the intermediate memories of controller 40. Accordingly, radio base station 8 samples the noise level via the passband every y seconds.

When the access protocol is carried out (step 56), a part of the protocol is to determine whether access to vehicle 1, or using the vehicle, is to be granted or approved. As a part of this determination, the safety flags are checked, and the status of the noise flags is used to ascertain whether relay station 16 is present and is being used in a relay station attack. The access may be denied if the noise flag is set, or if one or more of the safety flags is set. For example, access is possibly denied only if three of the flags have been set.

The noise test carried out by the radio base station offers considerable advantages by taking place in a dynamically self-adjusting manner to the HF environment in the vicinity of receiving antenna 12 of the vehicle. The test technique is tolerant with respect to interferences that do not originate with a relay station. Also, the frequency binvalues recorded may be used to determine a preferred channel for the data communications with key 4.

To a person of ordinary skill in this field, a plurality of modifications will be apparent, without deviating from the scope of the present invention described herein with reference to the accompanying drawings.

1-9. (canceled)

10. A safety system, comprising:
an electronic key having a transmitter; and
a secured object having a radio base station that includes a receiver, wherein the receiver communicates with the transmitter of the electronic key in order to exchange authentication data, and wherein the radio base station monitors a natural high frequency signal level received by the receiver, and wherein the radio base station detects an interference in the natural high frequency signal level in order to detect a relay station.

11. The safety system as recited in claim 10, wherein the radio base station generates random samples of a plurality of high frequency signal levels received via a plurality of frequency channels of the receiver.

12. The safety system as recited in claim 11, wherein the radio base station performs a noise test based on the random samples in order to detect the interference.

13. The safety system as recited in claim 12, wherein the noise test includes a condition that is considered to be satisfied if a selected number of the random samples exceed a predetermined threshold value.

14. The safety system as recited in claim 13, wherein the noise test is determined based on a Gaussian probability density function derived from the random samples.

15. The safety system as recited in claim 10, wherein the radio base station records over a selected time period a plurality of random samples for each of a plurality of frequency channels, in order to represent the natural high frequency signal level.

16. The safety system as recited in claim 12, wherein the radio base station and the key execute an access protocol for transmitting the authentication data, and wherein the access protocol includes a determination as to whether at least one of an access to the protected object and use of the protected object should be granted, based on the noise test.

17. The safety system as recited in claim 16, wherein the protected object is a vehicle (1).

18. A method for performing a security monitoring by a safety system including an electronic key that has a transmitter and a radio base station that includes a receiver, the radio base station being associated with a protected object, the method comprising:
transmitting authentication data from the transmitter to the receiver;
monitoring by the radio base station a natural high frequency signal level received by the receiver; and
detecting an interference in the natural high frequency signal level, whereby the interference is used to determine an existence of a relay station.
